(19) United States
(12) Patent Application Publication
(10) Pub. No.: US 2025/0094307 A1
(43) Pub. Date: Mar. 20, 2025

(54) AUTOMATED RESOURCES MANAGEMENT FOR SERVERLESS APPLICATIONS

(71) Applicant: Telefonaktiebolaget LM Ericsson (publ), Stockholm (SE)

(72) Inventors: Mohammad Abu LEBDEH, Montreal (CA); Mbarka SOUALHIA, Laval (CA); Fetahi WUHIB, Pincourt (CA)

(73) Assignee: Telefonaktiebolaget LM Ericsson (publ), Stockholm (SE)

(21) Appl. No.: 18/291,840

(22) PCT Filed: Jul. 26, 2021
(86) PCT No.: PCT/IB2021/056775

§ 371 Date: Jan. 24, 2024

(51) Int. Cl. G06F 11/34; G06F 11/30

(52) U.S. Cl. CPC G06F 11/3442; G06F 11/302; G06F 11/3414; G06F 2201/81

(57) ABSTRACT

A method by a computing system to determine a resource configuration for a function as a service application. The method includes generating, for each of one or more functions of the application, a performance profile of the function that indicates performance characteristics of the function with respect to an amount of resources allocated to the function, determining a resource configuration for the application based on an optimization objective and the performance profiles of the one or more functions, and deploying the application using the resource configuration determined for the application.

### TECHNICAL FIELD

Embodiments relate to the field of cloud computing, and more specifically to determining a resource configuration for a function as a service (FaaS) application.

### BACKGROUND

Cloud computing is the on-demand availability of computer system resources such as computing resources and data storage resources, where the resources are made available as a service and the user is not involved in the management of the services and the computer system resources used to provide said services. The term is generally used to describe data centers available to many users over a network (e.g., the internet).

The evolution of cloud computing is principally driven by three forces: (1) the need to provide computing services with the smallest possible overhead and highest possible performance; (2) the need for maintaining a required level of security/isolation; and (3) the requirement to provide computing services at the lowest possible cost. The cloud revolution that started with Infrastructure as a Service (IaaS), which was typically provided using virtual machines, reduced operating system overhead and evolved into what is known as Container as a Service (CaaS). The latest evolution is Function as a Service (FaaS), which allows developers to focus on the functional aspects of their applications and develop their applications as a collection of functions that call each other in some manner. FaaS may provide a platform that allows users/customers to develop, run, and manage application functionalities without the complexity of building and maintaining the infrastructure typically associated with developing and launching an application. Building an application following this model is one way of achieving a “serverless” architecture, and is typically used when building microservices applications.

FaaS usage is often charged per function execution based on how much resources (e.g., memory) are allocated to the function execution and/or how much time the function takes to execute. This takes the pay-as-you-go concept that made cloud computing very attractive to the next level where the cost for using FaaS can be pushed down even further. However, determining the optimal resource configuration for each function of the application that allows the application to have acceptable performance while also minimizing the cost of executing the application is difficult.

### SUMMARY

A method by a computing system to automatically determine a resource configuration for a function as a service application is disclosed. The method includes generating, for each of one or more functions of the application, a performance profile of the function that indicates performance characteristics of the function with respect to an amount of resources allocated to the function, determining a resource configuration for the application based on an optimization objective and the performance profiles of the one or more functions, and deploying the application using the resource configuration determined for the application.

A set of non-transitory machine-readable media having computer code stored therein, which when executed by a set of one or more processors of a computing system, causes the computing system to perform operations for automatically determining a resource configuration for a function as a service application is disclosed. The operations include generating, for each of one or more functions of the application, a performance profile of the function that indicates performance characteristics of the function with respect to an amount of resources allocated to the function, determining a resource configuration for the application based on an optimization objective and the performance profiles of the one or more functions, and deploying the application using the resource configuration determined for the application.

A computing device to automatically determine a resource configuration for a function as a service application is disclosed. The computing device includes one or more processors and a non-transitory machine-readable medium having computer code stored therein, which when executed by the one or more processors, causes the computing device to generate, for each of one or more functions of the application, a performance profile of the function that indicates performance characteristics of the function with respect to an amount of resources allocated to the function, determine a resource configuration for the application based on an optimization objective and the performance profiles of the one or more functions, and deploy the application using the resource configuration determined for the application . . .

### BRIEF DESCRIPTION OF THE DRAWINGS

The embodiments may best be understood by referring to the following description and accompanying drawings that are used to illustrate embodiments. In the drawings:

FIG. 1 is a diagram illustrating an automated resource management system, according to some embodiments.

FIG. 2 is a flow diagram illustrating an overall process for determining a resource configuration for a Function as a Service (FaaS) application, according to some embodiments.

FIG. 3 is a flow diagram illustrating a process for processing a deployment package, according to some embodiments.

FIG. 4 is a flow diagram illustrating a process for generating test cases for idempotent functions, according to some embodiments.

FIG. 5 is a diagram illustrating the insertion of calls to an input recorder function in application code, according to some embodiments.

FIG. 6 is a flow diagram illustrating a process for generating performance profiles for functions of an application, according to some embodiments.

FIG. 7 is a flow diagram illustrating a process for determining a feasible memory configuration range for a function, according to some embodiments.

FIG. 8 is a flow diagram illustrating a process for generating performance profiles in batch, according to some embodiments.

FIG. 9 is a flow diagram illustrating a process for generating performance profiles for individual functions, according to some embodiments.

FIG. 10 is a flow diagram illustrating a process for determining a memory configuration that optimizes an objective, according to some embodiments.

FIG. 11 is a flow diagram illustrating a process for determining whether performance profiles of functions accurately reflect the actual performances of the functions, according to some embodiments.

FIG. 12 is a flow diagram illustrating a process for automatically determining a resource configuration for a function as a service application, according to some embodiments.

FIG. 13A illustrates connectivity between network devices (NDs) within an exemplary network, as well as three exemplary implementations of the NDs, according to some embodiments.

FIG. 13B illustrates an exemplary way to implement a special-purpose network device according to some embodiments.

### DETAILED DESCRIPTION

The following description describes methods and apparatus for determining a resource configuration for a function as a service (FaaS) application. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of various embodiments. It will be appreciated, however, by one skilled in the art that embodiments may be practiced without such specific details. In other instances, control structures, gate level circuits and full software instruction sequences have not been shown in detail in order not to obscure embodiments. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, determining the optimal resource configuration for each function of a FaaS application such that an optimization objective is fulfilled is quite difficult. Existing solutions typically require manual input from the user to determine the functions and/or resource configurations to be evaluated (e.g. the memory configurations to be evaluated and the relationship between the amount of resources allocated and function performance). Also, existing solutions do not dynamically adjust resource configuration decisions. That is, they do not update their resource configuration decisions once the decisions are made. As such, they do not take into account the performance variance observed in serverless platforms and as a result their resource configuration decisions are not kept up-to-date. Also, existing solution do not consider multiple objectives to be optimized. Rather, they attempt to optimize either the performance of the application or the cost (e.g., financial and/or computing cost) of executing the application but not both. Given the above, there is a need for a system to determine the resource configuration for a FaaS application in a manner that minimizes cost while ensuring the required/expected performance.

Embodiments described herein allow for determining the resource configuration for a FaaS application (which may include the resource configurations for the functions of the application). An embodiment is a method by a computing system to determine a resource configuration for a FaaS application. The method includes generating, for each of one or more functions of the application, a performance profile of the function that indicates performance characteristics of the function with respect to an amount of resources allocated to the function, determining a resource configuration for the application based on an optimization objective and the performance profiles of the one or more functions, and deploying the application using the resource configuration determined for the application. In an embodiment, the method further includes determining whether a performance profile of a particular function of the one or more functions accurately reflects an actual performance of the particular function, updating the performance profile of the particular function in response to a determination that the performance profile of the particular function does not accurately reflect the actual performance of the particular function, determining an updated resource configuration for the application based on the updated performance profile of the particular function, and assigning the updated resource configuration to the application.

An advantage of embodiments disclosed herein is that they determine a resource configuration (e.g., a memory configuration) for an application in a manner that attempts to optimize multiple possibly conflicting objectives (e.g., minimize cost (financial and/or computing cost) and maximize performance). Also, an advantage of embodiments disclosed herein is that they may generate performance profiles for functions of the application using a minimal/reduced number of performance data points (e.g., without needing to test all possible memory configurations supported by the FaaS platform), which reduces the computing time/resources incurred to generate the performance profiles. Also, an advantage of embodiments disclosed herein is that they may generate test cases for the idempotent functions of the application, which can be used to profile the functions by executing individual functions instead of executing the entire application, which reduces the computing time/resources incurred. Also, an advantage of embodiments disclosed herein is that they may dynamically update the performance profiles of the functions and adjust the resource configurations assigned to the functions to adapt to the variation in performance of the FaaS platform. Embodiments are further described herein below with reference to the accompanying figures.

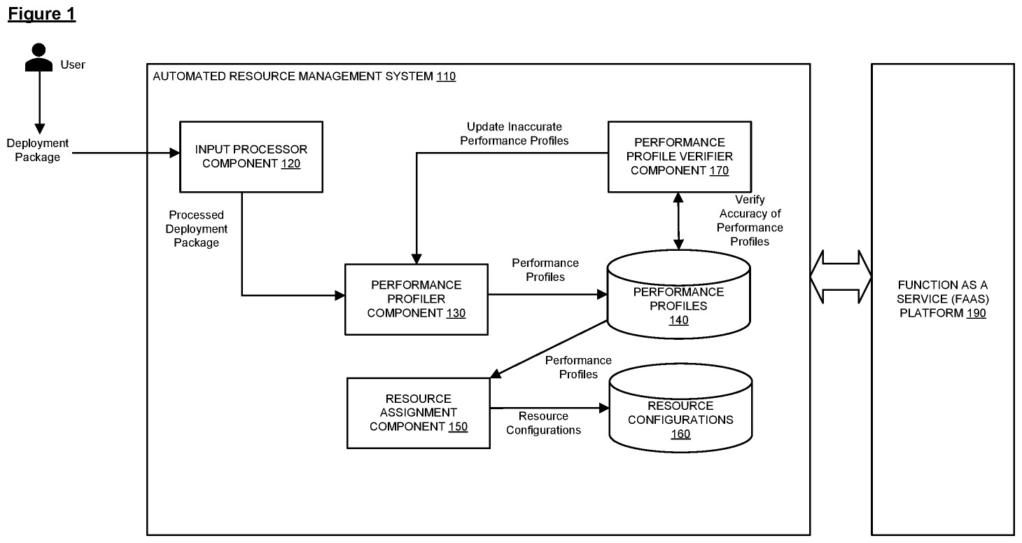

FIG. 1 is a diagram illustrating an automated resource management system, according to some embodiments.

As shown in the diagram, the automated resource management system 110 includes an input processor component 120, a performance profiler component 130, a data storage for performance profiles 140, a resource assignment component 150, a data storage for resource configurations 160, and a performance profile verifier component 170. Also, as shown in the diagram, the automated resource management system 110 is communicatively coupled to a FaaS platform 190. The FaaS platform 190 may be a platform that allows users/customers to develop, run, and manage application functionalities without the complexity of building and maintaining the infrastructure typically associated with developing and launching an application. Building an application following this model is one way of achieving a “serverless” architecture, and is typically used when building microservices applications.

As will be described further herein, the automated resource management system 110 provides a framework to determine and update the resource configuration for a FaaS application. To deploy the application, a user provides a deployment package for the application to the automated resource management system 110 (e.g., using a standard interface such as an application programming interface (API) or a command-line interface (CLI)). The deployment package for the application may include a manifest file, one or more test cases for the application, and the application itself. The manifest file may include various information that the automated resource management system 110 may use to determine the resource configuration for the application such as the performance and/or cost requirements for the application. In one embodiment, the manifest file includes one or more of the following information: (1) application identification information such as the name of the application and the version of the application; (2) function metadata such as function names, function versions, and whether a function is an idempotent function or not (e.g., a true or false value)—as used herein, an idempotent function is a function that generates the same output each time it is executed with the same inputs; (3) the coefficients of the objective function, which controls the impact of each function on determining the optimal resource configurations; (4) application performance requirements (e.g., defined as the upper bound on the execution time of the application and upper bound on the acceptable error of the estimated execution time); and (5) test cases for the application and/or test cases for one or more functions of the application.

As will be further described further herein, the automated resource management system 110 may use the test cases for the application to simulate a realistic workload for the application in order to measure the performance of the application and its functions. The automated resource management system 110 may use the measured performance to generate performance profiles for the functions. The automated resource management system 110 may then use the performance profiles of the functions to determine the optimal resource configuration for each function.

The input processor component 120 may receive the deployment package and verify it to ensure that it is error-free and also verify that the application can be deployed on the FaaS platform 190. If verification is successful, the input processor component 120 may provide the deployment package to the performance profiler component 130. The performance profiler component 130 may generate performance profiles for the functions of the application, where the performance profile of a function indicates the performance characteristics of the function (e.g., execution times of the function) with respect to the amount of resources assigned to the function (e.g., amount of memory assigned to the function). The performance profiler component 130 may store the generated performance profiles in storage 140. The resource assignment component 150 may determine a resource configuration for the application (e.g., on a per function basis) based on the requirements of the application and the performance profiles generated by the performance profiler component 130 (e.g., which it can obtain from storage 140). The resource configuration for the application may include the resource configurations for one or more functions of the application. The resource assignment component 150 may then deploy the application to the FaaS platform 190 using the resource configuration determined for the application. The resource assignment component 150 may store the resource configuration for the application in storage 160. The performance profile verifier component 170 may monitor the performance of the functions of the application (e.g., using an interface with the FaaS platform 190) and determine whether the performance profiles of the functions accurately reflect the actual performance of the functions (i.e., verify the accuracy of the performance profiles). If one or more of the performance profiles are determined to be inaccurate, then the performance profile verifier component 170 may send a request to the performance profiler component 130 to update the inaccurate performance profiles accordingly.

For sake of illustration, embodiments where the resource configuration is a memory configuration (e.g., the amount of memory assigned/allocated) are primarily described herein. It should be understood, however, that different types of resource configurations can be used.

Also, it should be noted that the memory configuration assigned may impact other types of resource configurations such as computing/processing resources (e.g., amount of CPU).

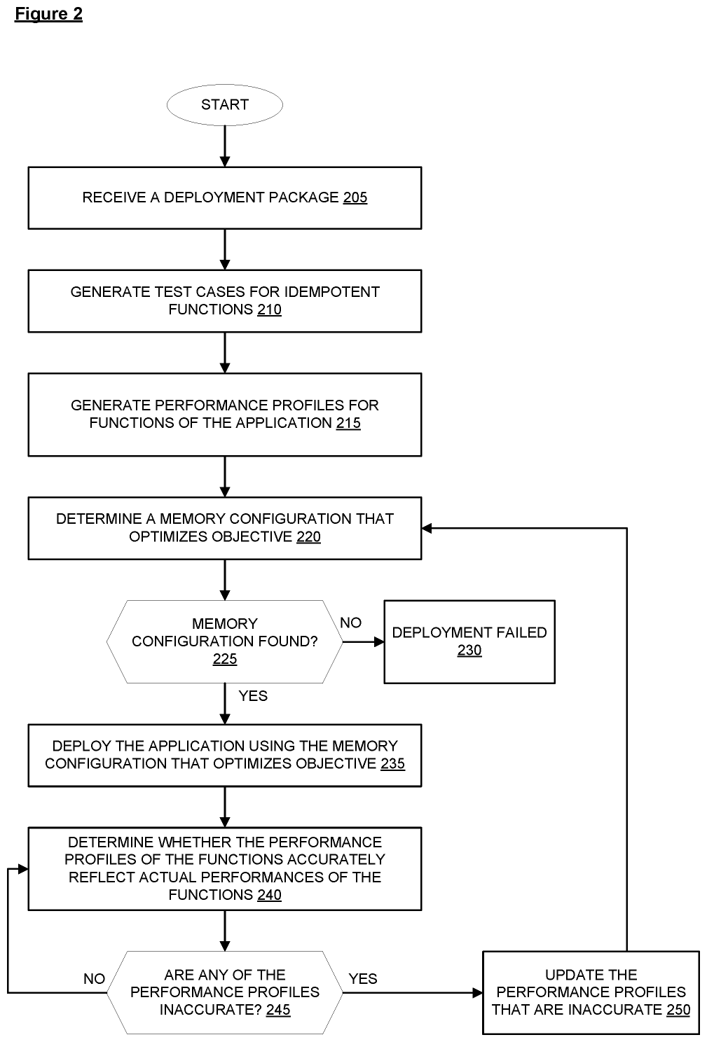

FIG. 2 is a flow diagram illustrating an overall process for determining a resource configuration for a FaaS application, according to some embodiments. In one embodiment, the process is implemented by the automated resource management system 110. The process may be implemented using hardware, software, and/or firmware.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

The process begins at block 205, where the automated resource management system 110 receives a deployment package for an application. The deployment package for the application may include information about the different functions that are included in the application, where to send the output of the application, and optimization objectives in terms of application performance (e.g., end-to-end delay of a call to the application) and/or cost requirements for the application (e.g., the amount of money charged by the FaaS platform 190 per application invocation).

At block 210, the automated resource management system 110 generates test cases for idempotent functions of the application (e.g., as indicated by a manifest file). These test cases may be used later to measure the performance of the idempotent functions.

At block 215, the automated resource management system 110 generates performance profiles for the functions of the application, where the performance profile a function indicates the execution times of the function with respect to the amount of memory assigned to the function.

At block 220, the automated resource management system 110 determines a memory configuration for each function of the application that fulfills the optimization objective (e.g., with respect to cost and/or performance) of the application based on the generated performance profiles (and knowledge of how much different memory configurations will cost). Examples of such optimization objectives include the best performance for a given financial cost or given a minimum acceptable performance level, the minimum financial cost.

At decision block 225, the automated resource management system 110 determines whether a valid memory configuration was found that satisfies the optimization constraints. If not, at block 230, the deployment fails. Otherwise, if a valid memory configuration was found, at block 235, the automated resource management system 110 deploys the application (on the FaaS platform 190) using the memory configuration that it determined to optimize the objective.

At block 240, the automated resource management system 110 determines whether the performance profiles of the functions accurately reflect the actual performances of the functions. At decision block 245, the automated resource management system 110 determines whether any of the performance profiles are inaccurate. If not, the process proceeds back to block 240 to continue to monitor the accuracy of the performance profiles. Otherwise, if any of the performance profiles are determined to be inaccurate, then at block 250, the automated resource management system 110 updates the performance profiles that are inaccurate and the process proceeds back to block 220 to determine an updated memory configuration for the application based on the updated performance profiles.

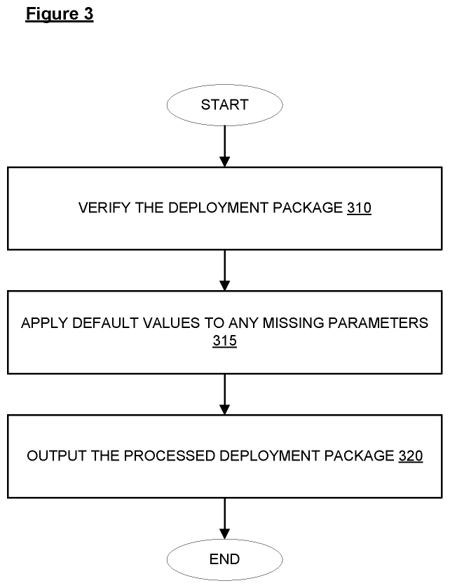

FIG. 3 is a flow diagram illustrating a process for processing a deployment package, according to some embodiments. The process may be implemented by the input processor component 120.

The process may begin when the input processor component 120 receives a deployment package for an application. At block 310, the input processor component 120 verifies the deployment package. The input processor component 120 may do this by verifying that the deployment package is formatted correctly and that all mandatory fields/parts are provided. The input processor component 120 may also verify that the application can be deployed on the FaaS platform 190 by assigning the largest amount of memory to each function and using the test cases for the application to verify that the application can be executed properly. At block 315, the input processor component 120 applies default values to any missing parameters. In one embodiment, the choice of default values is static while in other embodiments the choice of default values is dynamic and depends on the policy of the operator and the current state of the FaaS platform 190. At block 320, the input processor component 120 outputs the processed deployment package (and provides it to the performance profiler component 130).

The performance profiler component 130 generates performance profiles for one or more functions of the application and updates any performance profiles when they become inaccurate. The performance profiler component 130 may also perform other tasks to support the generation of performance profiles. For example, the performance profiler component 130 may generate test cases for idempotent functions of the application, which can be used to collect the performance measurements of those functions. The performance profiler component 130 may also determine the feasible memory configuration range for one or more functions of the application.

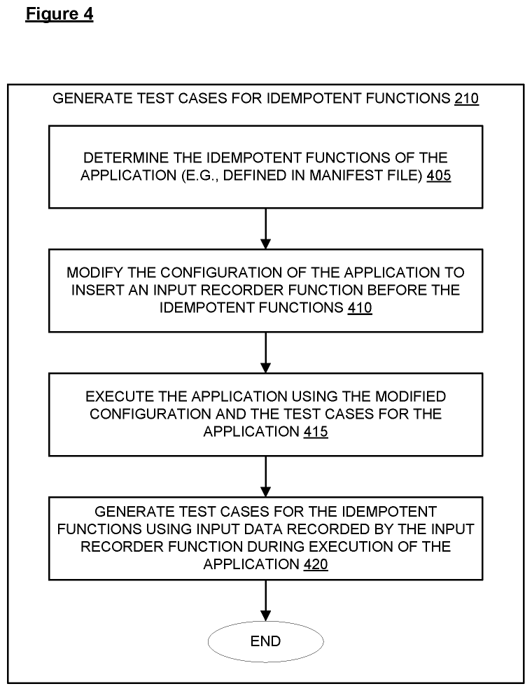

FIG. 4 is a flow diagram illustrating a process for generating test cases for idempotent functions, according to some embodiments. The process may be used to implement the operation of block 210. In one embodiment, the process is implemented by the performance profiler component 130. The performance profiler component 130 may generate test cases for the idempotent functions of the application which do not have any test cases in the deployment package. The generated test cases can be used later to generate performance profiles for these functions.

At block 405, the performance profiler component 130 determines the idempotent functions of the application (e.g., as defined in the manifest file).

At block 410, the performance profiler component 130 modifies the configuration of the application to insert an input recorder function before the idempotent functions. The performance profiler component 130 may disconnect the inputs to the idempotent functions and connect them as inputs to the input recorder function, and then connect the outputs of the input recorder functions as inputs to the idempotent functions. The input recorder function is a function that is used to capture the inputs of the idempotent functions and store those inputs so that they can later be used to generate test cases for the idempotent functions.

At block 415, the performance profiler component 130 executes the application using the modified configuration (from block 410) and the test cases for the application (e.g., the test cases included in the deployment package for the application). During execution, the input recorder function may capture and store the inputs to each of the idempotent functions.

At block 420, the performance profiler component 130 generates test cases for the idempotent functions using data recorded by the input recorder function during execution of the application. As a result, the number of test cases generated for an idempotent function may be equal to the number of test cases for the application.

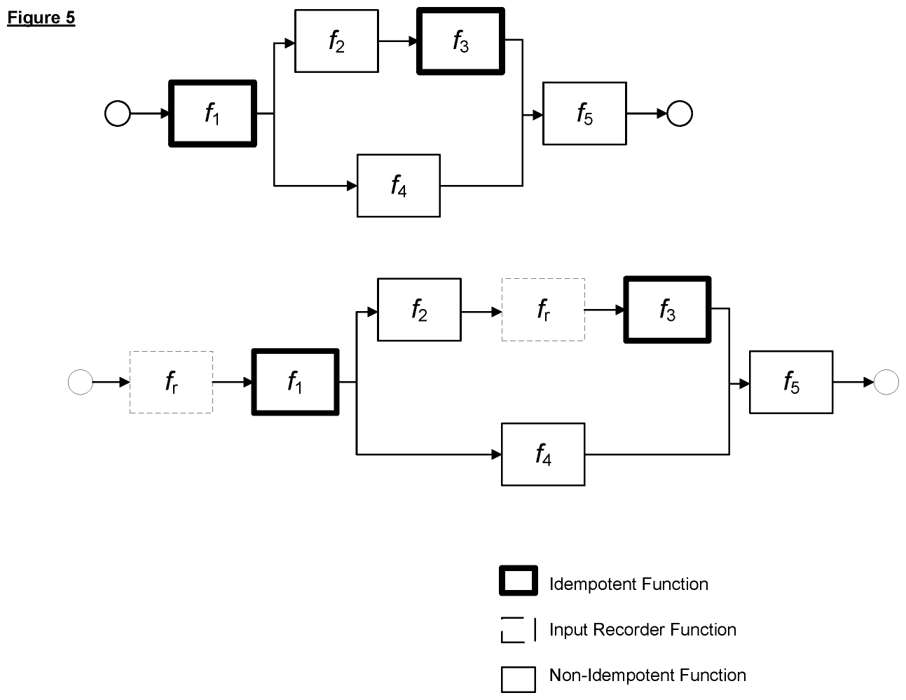

FIG. 5 is a diagram illustrating the insertion of calls to an input recorder function in application configuration, according to some embodiments. As shown in the diagram, an application configuration may include function calls that are arranged as shown in the diagram. For example, the output of function ƒ₁ may be provided as inputs to function ƒ₂ and function ƒ₄. The output of function ƒ₂ may be provided as input to function ƒ₃, which in turn provides its output as input to function ƒ₅. The output of function ƒ₄ may also be provided to function ƒ₅. In the example shown in the diagram, functions ƒ₁ and ƒ₃ are idempotent functions and functions ƒ₂, ƒ₄, and ƒ₅ are non-idempotent functions.

An input recorder function ƒᵣ may be inserted before each of the idempotent functions. For example, as shown in the diagram, an input recorder function ƒᵣ may be inserted before function ƒ₁ and function ƒ₃, respectively. The inputs to each of the idempotent functions may be provided as inputs to the input recorder function so that the input recorder function can record/store those inputs.

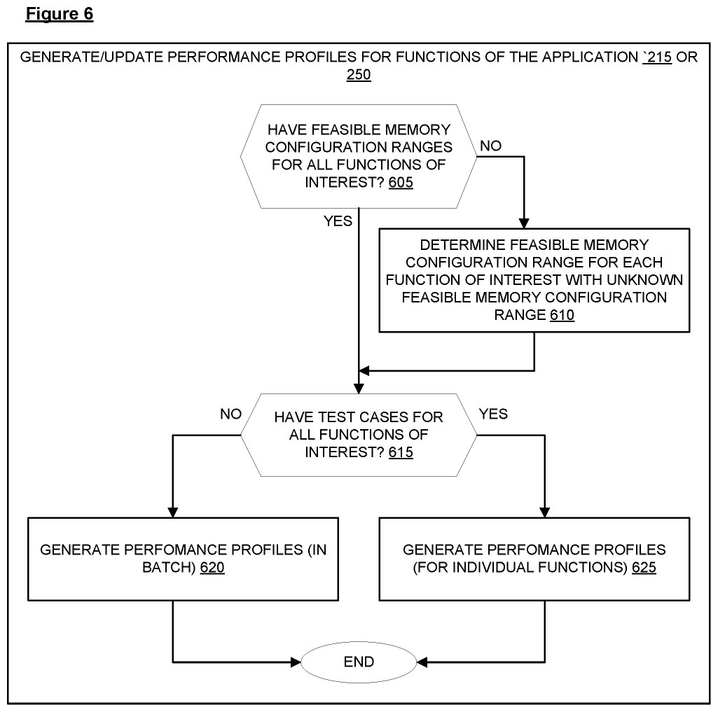

FIG. 6 is a flow diagram illustrating a process for generating performance profiles for functions of an application, according to some embodiments. The process may be used to implement the operation of block 215 (e.g., to generate new performance profiles) and/or 250 (e.g., to update existing performance profiles). In one embodiment, the process is implemented by the performance profiler component 130.

The automated resource management system 110 may generate a performance profile for each function of the application. The performance profile of a function indicates a performance characteristics of the function with respect to an amount of resources assigned to the function. For example, the performance profile of a function may indicate the relationship between the feasible memory configurations of the function and its execution time. In one embodiment, it can be defined as a mathematical function that takes a memory configuration as input and provides the estimated execution time of the function (if the function is assigned the memory configuration) as output. To generate a performance profile for a function, the automated resource management system 110 may collect a number of data points based on executing that function (e.g., the execution times of the function when the function is executed using different memory configurations). The number of data points that are needed may vary from one function to another. Two types of approaches for collecting data points are disclosed herein. The first approach is to execute the application using tests cases for the application when a data point is needed. The second approach is to execute only the function of interest using the test cases for the function. The second approach typically has less overhead in terms of cost and time compared to the first approach if the functions of interest are a subset of the functions of the application. However, the second approach may require test cases for the functions of interest. The second approach may be useful when there is a need to update a performance profile of a function that is determined to be inaccurate.

At block 605, the performance profiler component 130 determines whether it has feasible memory configuration ranges for all functions of interest. If not, at block 610, the performance profiler component 130 determines a feasible memory configuration range for each function of interest with an unknown feasible memory configuration range and the process proceeds to decision block 615. Otherwise, if the performance profile component 130 determines that it has feasible memory configuration ranges for all functions of interest then the process may proceed directly to decision block 615 without performing the operation of block 610.

The feasible memory configurations of a function are the set of memory configurations (e.g., amounts of memory), that if any memory configuration in that set is assigned to that function, the function finishes execution without throwing an error related to the assigned memory configuration (e.g., a time out error or an out of memory error). It should be noted that although the FaaS platform 190 may support assigning a certain range of memory configurations to functions, this does not necessarily mean that the entire memory configuration range will work for every function since functions can have different minimum memory requirements. For example, the FaaS platform 190 may be capable of assigning memory values between 128 megabytes and 3,008 megabytes in 64 megabyte increments. However, it is possible to have a function that raises an error and fails if it is assigned a memory value that is less than 512 megabytes. In this case, the feasible memory configuration range of that function is from 512 megabytes to 3,008 megabytes in 64 megabyte increments.

At decision block 615, the performance profile component 130 determines whether it has test cases for all functions of interest. If not, at block 620, the performance profiler component 130 generates performance profiles (in batch (i.e., the first approach mentioned above)). Otherwise, if the performance profile component 130 determines that is has test cases for all functions of interest then at block 625, the performance profile component 130 generates performance profiles (for individual functions (i.e., the second approach mentioned above)).

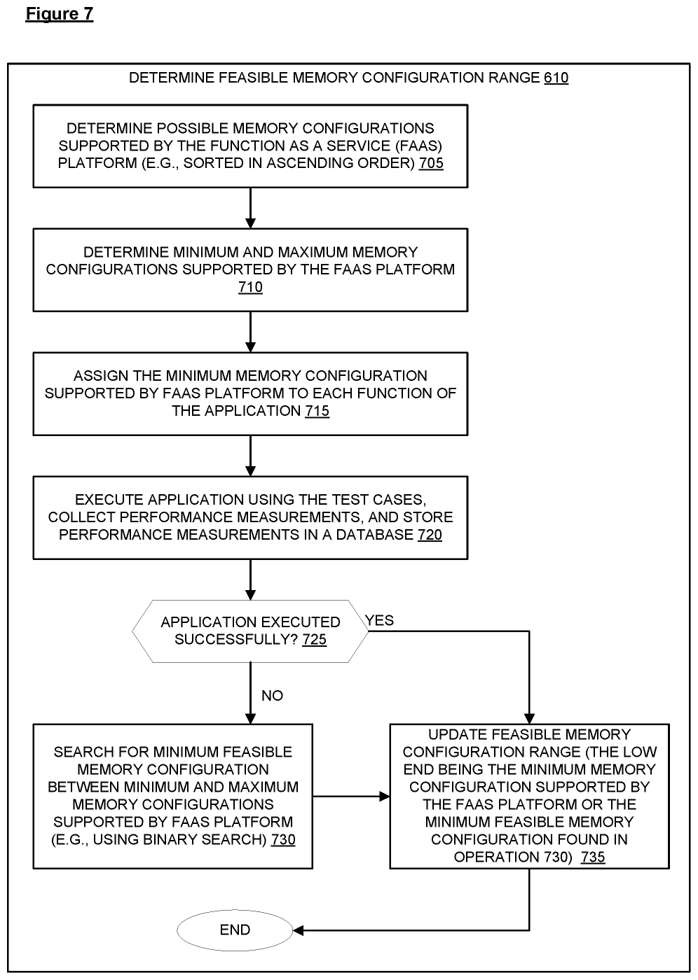

FIG. 7 is a flow diagram illustrating a process for determining a feasible memory configuration range for a function, according to some embodiments. The process may be used to implement the operation of block 610. In one embodiment, the process is implemented by the performance profiler component 130.

At block 705, the performance profiler component 130 determines the possible memory configurations supported by the FaaS platform 190 (e.g., sorted in ascending order).

At block 710, the performance profiler component 130 determines the minimum and maximum memory configurations supported by the FaaS platform 190.

At block 715, the performance profiler component 130 assigns the minimum memory configuration supported by the FaaS platform 190 to each function of the application.

At block 720, the performance profiler component 130 executes the application using the test cases for the application, collects performance measurements, and stores the collected performance measurements in a database (or other type of storage). The same process may be repeated using the maximum memory configuration supported by the FaaS platform 190.

At decision block 725, the performance profiler component 130 determines whether the application successfully executed. If so, at block 735 the performance profiler component 130 updates the feasible memory configuration ranges for the functions (such that the low end of the range is the minimum memory configuration supported by the FaaS platform 190). Otherwise, if the performance profile component 130 determines that the application did not execute successfully, then the performance profile component 130 may determine the functions that failed to execute due to memory insufficiency. Then, at block 730, the performance profiler component 130 searches for the minimum feasible memory configuration for each of those function (somewhere between the minimum and maximum memory configurations supported by the FaaS platform 190). In one embodiment, the performance profiler component 130 uses a binary search algorithm to search for the minimum feasible memory configuration (e.g., by assigning the memory configuration that is in the “middle” of the minimum and maximum memory configurations until the function executes successfully). Then, at block 735, the performance profiler component 130 updates the feasible memory configuration range for the function (where the low end of the range is the minimum memory configuration that was found in the operation of block 730). The performance profiler component 130 may store the feasible memory configuration range for the function in storage (e.g., storage 140).

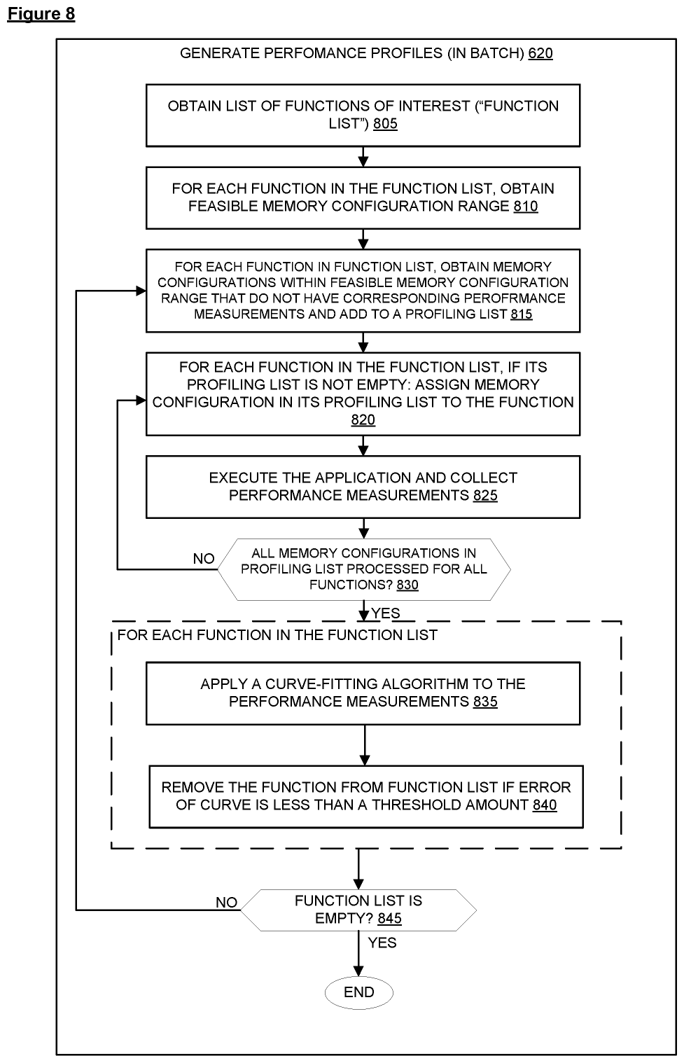

FIG. 8 is a flow diagram illustrating a process for generating performance profiles in batch, according to some embodiments. The process may be used to implement the operation of block 620. In one embodiment, the process is implemented by the performance profiler component 130.

As mentioned above, the automated resource management system 110 may need data points (e.g., memory and execution time pairs) to generate a performance profile that maps the memory configuration assigned to a function to the execution time of that function. The process shown in FIG. 8 can generate performance profiles for multiple functions in parallel (in batch). The process collects the data points needed by executing the application itself. It may iteratively collect data points for the functions of interest, and then apply a curve fitting algorithm to represent the relationship between the memory configuration and execution time. The process may be repeated until the accuracy of the performance profiles meets the requirement indicated in the manifest file.

At block 805, the performance profiler component 130 obtains a list of the functions of interest (referred to as the “function list”—the list of functions for which performance profiles are to be generated).

At block 810, for each function in the function list, the performance profiler component 130 obtains the feasible memory configuration range for the function (e.g., from storage 140).

At block 815, for each function in the function list, the performance profiler component 130 obtains the memory configurations within the feasible memory configuration range that do not have corresponding performance measurements and adds them to a profiling list. For example, the performance profiler component 130 may find, for each function, the half-way memory configuration between every two consecutive memory configurations that have corresponding performance measurements in the feasible memory configuration range and add them to the profiling list to be used later in the profiling.

At block 820, for each function in the function list, if its profiling list is not empty, then the performance profiler component 130 assigns a memory configuration in the profiling list to the function.

At block 825, the performance profiler component 130 executes the application and collects performance measurements.

At decision block 830, the performance profiler component 130 determines whether all memory configurations in the profiling list have been processed for all functions. If not, the process proceeds to block 820 to process additional memory configurations. Otherwise, if the performance profiler component 130 determines that all memory configurations in the profiling list have been processed, then the performance profiler component 130 performs the operations of blocks 835 and 840 for each function in the function list. At block 835, the performance profiler component 130 applies a curve-fitting algorithm (e.g., least-squares fitting of a fifth order polynomial curve) to the performance measurements of the function. While, for the sake of example, an embodiment is described here where the resource configuration includes a configuration for a single type of resource (i.e., memory), some embodiments may use a resource configuration that includes configurations for multiple types of resources (e.g., memory and CPU). In such embodiments, a surface-fitting algorithm may be used instead of a curve-fitting algorithm. The performance profiler component 130 may then determine the error between the actual data points and the curve. At block 840, the performance profiler component 130 removes the function from the function list if the error of the curve is less than a threshold amount.

At decision block 845, the performance profiler component 130 determines whether the function list is empty. If not, the process proceeds to block 815 to obtain additional data points. Otherwise, if the function list is empty, then the process ends.

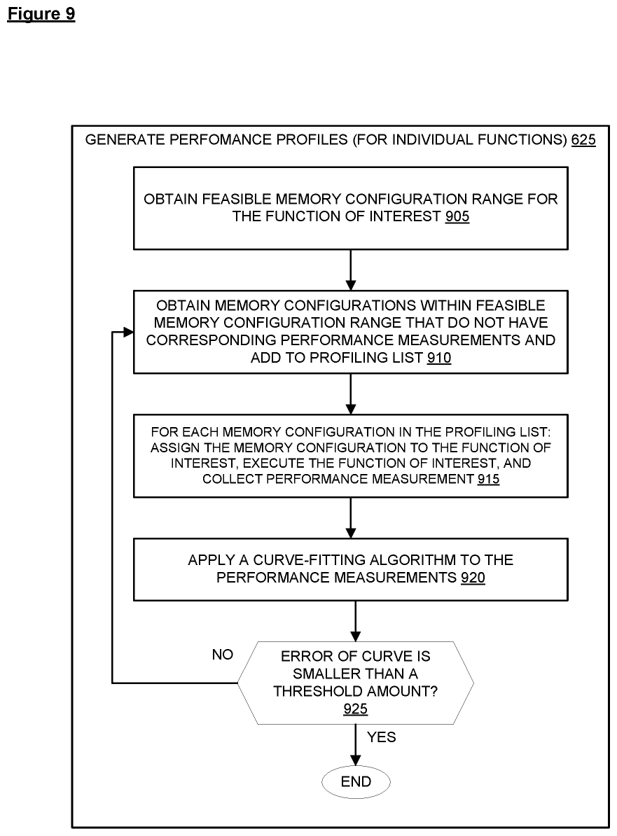

FIG. 9 is a flow diagram illustrating a process for generating performance profiles for individual functions, according to some embodiments. The process may be used to implement the operation of block 625. In one embodiment, the process is implemented by the performance profiler component 130.

Similar to the batch performance profile generation process (e.g., the process shown in FIG. 8), this process iteratively collects data points for the function of interest and applies a curve-fitting algorithm until the error of the curve is less than a threshold amount. However, a difference between this process and the batch performance profile generation process is that this process works on a per-function basis whereas the batch performance profile generation process generates performance profiles for multiple functions in parallel. Another difference between this process and the batch performance profile generation process is that this process collects data points by executing the function itself whereas the batch performance profile generation process executes the entire application.

At block 905, the performance profiler component 130 obtains the feasible memory configuration range for the function of interest.

At block 910, the performance profile component 130 obtains memory configurations within the feasible memory configuration range that do not have corresponding performance measurements and adds them to a profiling list. For example, the performance profiler component 130 may find the half-way memory configuration between every two consecutive memory configurations that have corresponding performance measurements in the feasible memory configuration range and add them to the profiling list to be used later in the profiling.

At block 915, for each memory configuration in the profiling list, the performance profile component 130 assigns the memory configuration to the function of interest, executes the function of interest (using test cases for the function), and collects performance measurements (and may store the performance measurements in storage 140).

At block 920, the performance profile component 130 applies a curve-fitting algorithm (e.g., least-squares fitting) to the performance measurements.

The performance profiler component 130 may determine the error between the actual data points and the curve. At decision block 925, the performance profile component 130 determines whether the error of the curve is less than a threshold amount (e.g., which may have been provided by the user). If not, the process proceeds to block 910 to obtain additional data points. Otherwise, if the performance profile component 130 determines that the error of the curve is less than a threshold amount, then the process ends.

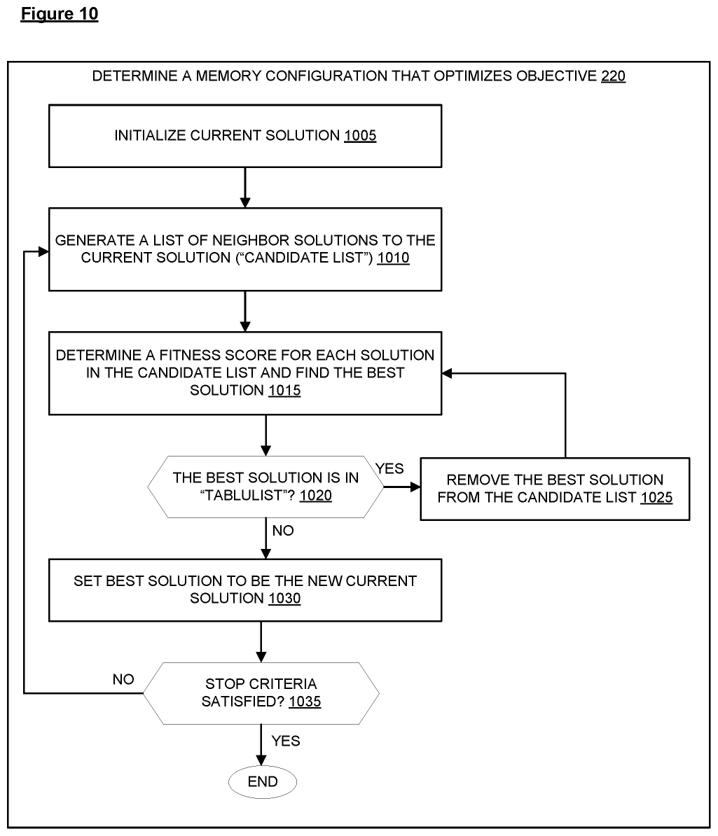

FIG. 10 is a flow diagram illustrating a process for determining a memory configuration that optimizes an objective, according to some embodiments. The process may be used to implement the operation of block 220. In one embodiment, the process is implemented by the resource assignment component 150.

The process may determine the optimal memory configurations for the functions of the application that optimizes an objective (e.g., financial cost and performance). Various optimization algorithms can be used to determine the optimal memory configuration. Examples of such algorithms include a Tabu search algorithm, a particle swarm optimization algorithm, and a genetic algorithm. The process shown in the diagram uses the Tabu search algorithm.

The process is merely provided as an example to help illustrate an embodiment. One of ordinary skill in the art will understand that the process can be adjusted/modified to use other types of optimization algorithms. It should be noted that optimization algorithms (e.g., including the Tabu search algorithm) may use heuristics to find a near-optimal solutions in a reasonable amount of time, and thus the solutions found using such optimization algorithms may not necessary be “optimal” in a strict mathematical sense (but provide a good approximation).

At block 1005, the resource assignment component 150 initializes a current solution. The resource assignment component may do this by obtaining the performance profiles of the functions (e.g., from storage 140), randomly selecting a feasible memory configuration for each function using its list of performance profiles, and adding the obtained solution S to a “tabulist.” This initial solution may serve as the current solution.

At block 1010, the resource assignment component 150 generates a list of neighbor solutions to the current solution (referred to as the “candidate list”). A neighbor solution can be generated by changing the memory configuration assigned to a function in the current solution. Thus, each solution in the candidate list may be a solution that differs from the current solution in the memory configuration assigned to one function.

At block 1015, the resource assignment component 150 determines a fitness score (e.g., that indicates how well the optimization objective is achieved) for each solution in the candidate list and finds the best solution. The fitness score may indicate how well a solution fulfills the objective (e.g., in terms of financial cost (using the FaaS pricing information for the assigned memory configurations) and performance).

At decision block 1020, the resource assignment component 150 determines whether the best solution is in the “tabulist.” If so, at block 1025, the resource assignment component 150 removes the best solution from the candidate list and the process moves to block 1015. Otherwise, if the resource assignment component 150 determines that the best solution is not in the “tabulist,” then at block 1030, it sets the best solution to be the new current solution.

At decision block 1035, the resource assignment component 150 determines whether a stop criterion (e.g., reaching maximum number of iterations or reaching a timeout) has been satisfied. If not, the process moves to block 1010, otherwise, the process ends. When the stop criterion is satisfied, the process returns the generated/obtained solution (which may not necessarily be the “optimal” solution but a good approximation of the “optimal” solution) which indicates which memory configuration should be assigned to each function in the application.

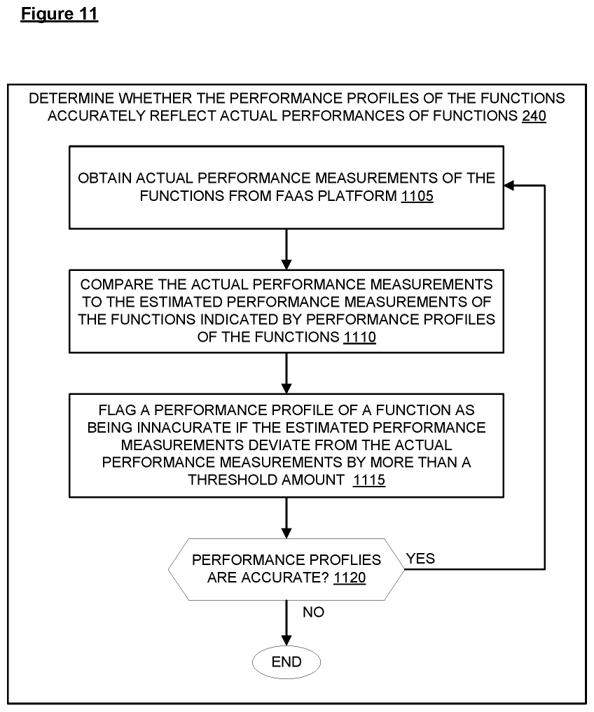

FIG. 11 is a flow diagram illustrating a process for determining whether performance profiles of functions accurately reflect the actual performances of the functions, according to some embodiments. The process may be used to implement the operation of block 240. In one embodiment, the process is implemented by the performance profile verifier component 170.

At block 1105, the performance profile verifier component 170 obtains actual performance measurements (e.g., execution times) of the functions from the FaaS platform 190.

At block 1110, the performance profile verifier component 170 compares the actual performance measurements to the estimated performance measurements of the functions as indicated by the performance profiles of the functions.

At block 1115, the performance profile verifier component 170 flags a performance profile of a function as being inaccurate if the estimated performance measurement deviates from the actual performance measurement by more than a threshold amount.

At decision block 1120, the performance profile verifier component 170 determines whether all of the performance profiles are accurate. If all performance profiles are accurate, then the process moves to block 1105 to continue to monitor the accuracy of the performance profiles (e.g., on a periodic basis). Otherwise, if any of the performance profiles are not accurate, then the process ends. This may trigger the operation of block 250 to update the inaccurate performance profiles.

Embodiments have been described that allow for determining a resource configuration for a FaaS application. The use of FaaS provides several benefits such as scalability, flexibility, agility, and acceleration. Thus, it is anticipated that many applications will move to a FaaS platform in the future. For example, in the telecommunications field, FaaS will likely play an important role in the evolution of Operation Support Systems (OSS) that includes management functions such as service fulfillment, provisioning and activation, service assurance, fault management, monitoring and customer care. With FaaS, those OSS functions that include many procedures/steps may be executed as requested while optimizing cost since the cost will be charged per function execution. Embodiments disclosed herein may be used to manage and configure their resources in a manner that minimizes cost while keeping an acceptable level of performance for the deployed application. Embodiments may be implemented and deployed within any distributed or centralized FaaS system that uses online stream data.

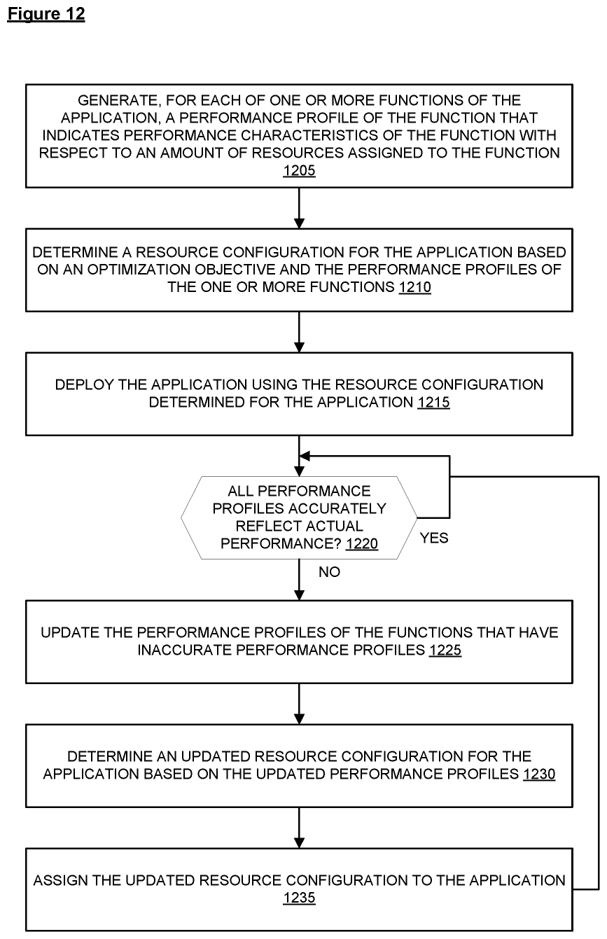

FIG. 12 is a flow diagram illustrating a process for determining a resource configuration for a function as a service application, according to some embodiments. In one embodiment, the process is implemented by a computing system (e.g., a computing system implementing the automated resource management system 110).

At block 1205, the computing system generates, for each of one or more functions of the application, a performance profile of the function that indicates performance characteristics of the function with respect to an amount of resources allocated to the function. In one embodiment, the computing system determines, for each of the one or more functions, a feasible resource configuration range for the function. In one embodiment, the feasible resource configuration range of a function is determined using a binary search algorithm. In one embodiment, a performance profile of a particular function of the one or more functions is generated based on iteratively executing the application using a plurality of feasible resource configurations within a feasible resource configuration range of the particular function and test cases for the application. In one embodiment, a performance profile of a particular function of the one or more functions is generated based on iteratively executing the particular function using a plurality of feasible resource configurations within a feasible resource configuration range of the particular function and test cases for the particular function. In one embodiment, the computing system generates the test cases for the particular function based on modifying a configuration of the application to insert an input recorder function before the particular function and executing the application with the modified configuration to collect input data recorded by the input recorder function. In one embodiment, the performance profile of the particular function is further generated based on applying a curve-fitting algorithm to a plurality of performance measurements of the particular function corresponding to the plurality of feasible resource configurations.

At block 1210, the computing system determines a resource configuration for the application based on an optimization objective and the performance profiles of the one or more functions. In one embodiment, the resource configuration for the application is a memory configuration for the application (e.g., the amount of memory to assign to each function of the application). In one embodiment, the resource configuration for the application is determined based on executing an optimization algorithm using the optimization objective and the performance profiles of the one or more functions. In one embodiment, the optimization algorithm is one of a Tabu search algorithm, a particle swarm optimization algorithm, and a genetic algorithm. Of course, other types of optimization algorithms may be used.

At block 1215, the computing system deploys the application (on the FaaS platform) using the resource configuration determined for the application.

In one embodiment, at decision block 1220, the computing system determines whether all of the performance profiles accurately reflect the actual performance of the functions. If so, the computing system may repeat the operation of decision block 1220 (e.g., periodically) to monitor the accuracy of the performance profiles.

Otherwise, if the computing system determines that any of the performance profiles of the functions are inaccurate, then at block 1225, the computing system updates the performance profiles of the functions that have inaccurate performance profiles. In one embodiment, a performance profile of a function is determined not to accurately reflect the actual performance of the function based on a determination that an estimated performance measurement of the function indicated by the performance profile of the function deviates from an actual performance measurement of the function by more than a threshold amount.

At block 1230, the computing system determines an updated resource configuration for the application based on the updated performance profiles.

At block 1235, the computing system assigns the updated resource configuration to the application (so that the application is executed using the updated resource configuration).

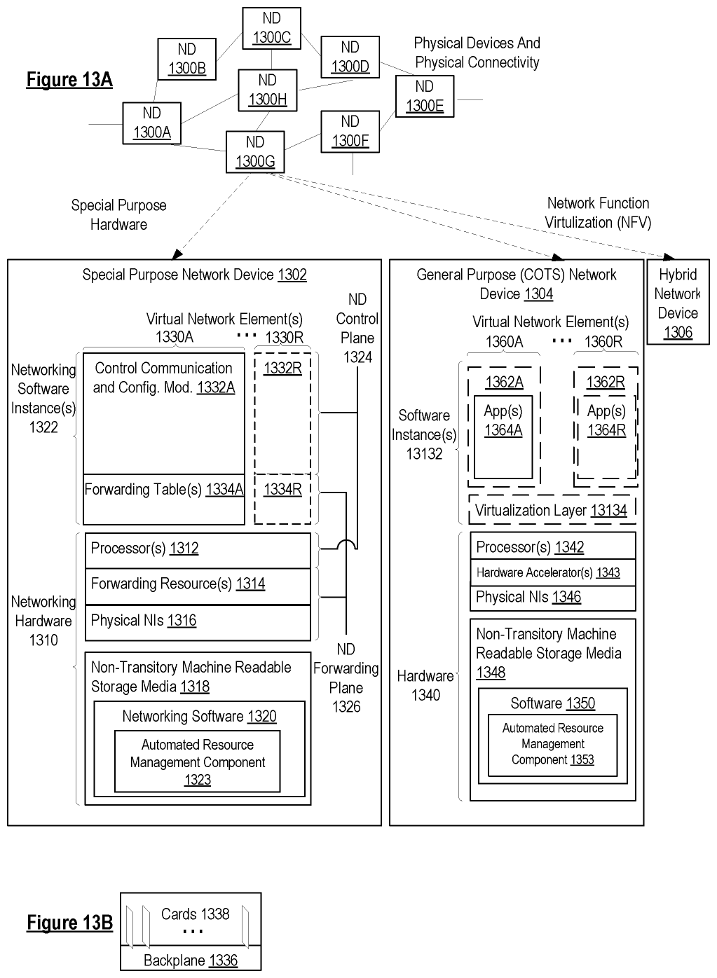

FIG. 13A illustrates connectivity between network devices (NDs) within an exemplary network, as well as three exemplary implementations of the NDs, according to some embodiments. FIG. 13A shows NDs 1300A-H, and their connectivity by way of lines between 1300A-1300B, 1300B-1300C, 1300C-1300D, 1300D-1300E, 1300E-1300F, 1300F-1300G, and 1300A-1300G, as well as between 1300H and each of 1300A, 1300C, 1300D, and 1300G. These NDs are physical devices, and the connectivity between these NDs can be wireless or wired (often referred to as a link). An additional line extending from NDs 1300A, 1300E, and 1300F illustrates that these NDs act as ingress and egress points for the network (and thus, these NDs are sometimes referred to as edge NDs; while the other NDs may be called core NDs).

Two of the exemplary ND implementations in FIG. 13A are: 1) a special-purpose network device 1302 that uses custom application-specific integrated-circuits (ASICs) and a special-purpose operating system (OS); and 2) a general purpose network device 1304 that uses common off-the-shelf (COTS) processors and a standard OS.

The special-purpose network device 1302 includes networking hardware 1310 comprising a set of one or more processor(s) 1312, forwarding resource(s) 1314 (which typically include one or more ASICs and/or network processors), and physical network interfaces (NIs) 1316 (through which network connections are made, such as those shown by the connectivity between NDs 1300A-H), as well as non-transitory machine readable storage medium/media 1318 having stored therein networking software 1320. During operation, the networking software 1320 may be executed by the networking hardware 1310 to instantiate a set of one or more networking software instance(s) 1322. Each of the networking software instance(s) 1322, and that part of the networking hardware 1310 that executes that network software instance (be it hardware dedicated to that networking software instance and/or time slices of hardware temporally shared by that networking software instance with others of the networking software instance(s) 1322), form a separate virtual network element 1330A-R. Each of the virtual network element(s) (VNEs) 1330A-R includes a control communication and configuration module 1332A-R (sometimes referred to as a local control module or control communication module) and forwarding table(s) 1334A-R, such that a given virtual network element (e.g., 1330A) includes the control communication and configuration module (e.g., 1332A), a set of one or more forwarding table(s) (e.g., 1334A), and that portion of the networking hardware 1310 that executes the virtual network element (e.g., 1330A).

In one embodiment software 1320 includes code such as automated resource management component 1323, which when executed by networking hardware 1310, causes the special-purpose network device 1302 to perform operations of one or more embodiments as part of networking software instances 1322 (e.g., to determine a resource configuration for a FaaS application).

The special-purpose network device 1302 is often physically and/or logically considered to include: 1) a ND control plane 1324 (sometimes referred to as a control plane) comprising the processor(s) 1312 that execute the control communication and configuration module(s) 1332A-R; and 2) a ND forwarding plane 1326 (sometimes referred to as a forwarding plane, a data plane, or a media plane) comprising the forwarding resource(s) 1314 that utilize the forwarding table(s) 1334A-R and the physical NIs 1316. By way of example, where the ND is a router (or is implementing routing functionality), the ND control plane 1324 (the processor(s) 1312 executing the control communication and configuration module(s) 1332A-R) is typically responsible for participating in controlling how data (e.g., packets) is to be routed (e.g., the next hop for the data and the outgoing physical NI for that data) and storing that routing information in the forwarding table(s) 1334A-R, and the ND forwarding plane 1326 is responsible for receiving that data on the physical NIs 1316 and forwarding that data out the appropriate ones of the physical NIs 1316 based on the forwarding table(s) 1334A-R.

FIG. 13B illustrates an exemplary way to implement the special-purpose network device 1302 according to some embodiments. FIG. 13B shows a special-purpose network device including cards 1338 (typically hot pluggable). While in some embodiments the cards 1338 are of two types (one or more that operate as the ND forwarding plane 1326 (sometimes called line cards), and one or more that operate to implement the ND control plane 1324 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1336 (e.g., a first full mesh coupling the line cards and a second full mesh coupling all of the cards).

Returning to FIG. 13A, the general purpose network device 1304 includes hardware 1340 comprising a set of one or more processor(s) 1342 (which are often COTS processors) and physical NIs 1346, as well as non-transitory machine readable storage medium/media 1348 having stored therein software 1350. During operation, the processor(s) 1342 execute the software 1350 to instantiate one or more sets of one or more applications 1364A-R. While one embodiment does not implement virtualization, alternative embodiments may use different forms of virtualization. For example, in one such alternative embodiment the virtualization layer 1354 represents the kernel of an operating system (or a shim executing on a base operating system) that allows for the creation of multiple instances 1362A-R called software containers that may each be used to execute one (or more) of the sets of applications 1364A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 1354 represents a hypervisor (sometimes referred to as a virtual machine monitor (VMM)) or a hypervisor executing on top of a host operating system, and each of the sets of applications 1364A-R is run on top of a guest operating system within an instance 1362A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1340, directly on a hypervisor (in which case the unikernel is sometimes described as running within a LibOS virtual machine), or in a software container, embodiments can be implemented fully with unikernels running directly on a hypervisor represented by virtualization layer 1354, unikernels running within software containers represented by instances 1362A-R, or as a combination of unikernels and the above-described techniques (e.g., unikernels and virtual machines both run directly on a hypervisor, unikernels and sets of applications that are run in different software containers).

The instantiation of the one or more sets of one or more applications 1364A-R, as well as virtualization if implemented, are collectively referred to as software instance(s) 1352. Each set of applications 1364A-R, corresponding virtualization construct (e.g., instance 1362A-R) if implemented, and that part of the hardware 1340 that executes them (be it hardware dedicated to that execution and/or time slices of hardware temporally shared), forms a separate virtual network element(s) 1360A-R.

The virtual network element(s) 1360A-R perform similar functionality to the virtual network element(s) 1330A-R—e.g., similar to the control communication and configuration module(s) 1332A and forwarding table(s) 1334A (this virtualization of the hardware 1340 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 1362A-R corresponding to one VNE 1360A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 1362A-R to VNEs also apply to embodiments where such a finer level of granularity and/or unikernels are used.

In certain embodiments, the virtualization layer 1354 includes a virtual switch that provides similar forwarding services as a physical Ethernet switch. Specifically, this virtual switch forwards traffic between instances 1362A-R and the physical NI(s) 1346, as well as optionally between the instances 1362A-R; in addition, this virtual switch may enforce network isolation between the VNEs 1360A-R that by policy are not permitted to communicate with each other (e.g., by honoring virtual local area networks (VLANs)).

In one embodiment, software 1350 includes code such as automated resource management component 1353, which when executed by processor(s) 1342, causes the general purpose network device 1304 to perform operations of one or more embodiments as part of software instances 1362A-R (e.g., to determine a resource configuration for a FaaS application).

The third exemplary ND implementation in FIG. 13A is a hybrid network device 1306, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1302) could provide for para-virtualization to the networking hardware present in the hybrid network device 1306.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1330A-R, VNEs 1360A-R, and those in the hybrid network device 1306) receives data on the physical NIs (e.g., 1316, 1346) and forwards that data out the appropriate ones of the physical NIs (e.g., 1316, 1346). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto. The specification and drawings are, accordingly, to be regarded in an illustrative sense rather than a restrictive sense.

1. A method by a computing system to determine a resource configuration for a function as a service application, the method comprising:
generating, for each of one or more functions of the application, a performance profile of the function that indicates performance characteristics of the function with respect to an amount of resources allocated to the function;
determining a resource configuration for the application based on an optimization objective and the performance profiles of the one or more functions; and
deploying the application using the resource configuration determined for the application.

2. The method of claim 1, wherein the resource configuration for the application is determined based on executing an optimization algorithm using the optimization objective and the performance profiles of the one or more functions.

3. The method of claim 2, wherein the optimization algorithm is one of a Tabu search algorithm, a particle swarm optimization algorithm, and a genetic algorithm.

4. The method of claim 1, further comprising:
determining whether a performance profile of a particular function of the one or more functions accurately reflects an actual performance of the particular function;
updating the performance profile of the particular function in response to a determination that the performance profile of the particular function does not accurately reflect the actual performance of the particular function;
determining an updated resource configuration for the application based on the updated performance profile of the particular function; and
assigning the updated resource configuration to the application.

5. The method of claim 4, wherein the performance profile of the particular function is determined not to accurately reflect the actual performance of the particular function based on a determination that an estimated performance measurement of the particular function indicated by the performance profile of the particular function deviates from an actual performance measurement of the particular function by more than a threshold amount.

6. The method of claim 1, further comprising:
determining, for each of the one or more functions, a feasible resource configuration range for the function.

7. The method of claim 6, wherein a performance profile of a particular function of the one or more functions is generated based on iteratively executing the application using a plurality of feasible resource configurations within a feasible resource configuration range of the particular function and test cases for the application.

8. The method of claim 6, wherein a performance profile of a particular function of the one or more functions is generated based on iteratively executing the particular function using a plurality of feasible resource configurations within a feasible resource configuration range of the particular function and test cases for the particular function.

9. The method of claim 8, further comprising:
generating the test cases for the particular function based on modifying a configuration of the application to insert an input recorder function before the particular function and executing the application with the modified configuration to collect input data recorded by the input recorder function.

10. The method of claim 8, wherein the performance profile of the particular function is further generated based on applying a curve-fitting algorithm to a plurality of performance measurements of the particular function corresponding to the plurality of feasible resource configurations.

11. The method of claim 6, wherein the feasible resource configuration range of a function is determined using a binary search algorithm.

12. The method of claim 1, wherein the resource configuration for the application is a memory configuration for the application.

13. A set of non-transitory machine-readable media having computer code stored therein, which when executed by a set of one or more processors of a computing system, causes the computing system to perform operations for determining a resource configuration for a function as a service application, the operations comprising:
generating, for each of one or more functions of the application, a performance profile of the function that indicates performance characteristics of the function with respect to an amount of resources allocated to the function;
determining a resource configuration for the application based on an optimization objective and the performance profiles of the one or more functions; and
deploying the application using the resource configuration determined for the application.

14. The set of non-transitory machine-readable media of claim 13, wherein the resource configuration for the application is determined based on executing an optimization algorithm using the optimization objective and the performance profiles of the one or more functions.

15. A computing device to determine a resource configuration for a function as a service application, the computing device comprising:
one or more processors; and
a non-transitory machine-readable medium having computer code stored therein, which when executed by the one or more processors, causes the computing device to:
generate, for each of one or more functions of the application, a performance profile of the function that indicates performance characteristics of the function with respect to an amount of resources allocated to the function,
determine a resource configuration for the application based on an optimization objective and the performance profiles of the one or more functions, and
deploy the application using the resource configuration determined for the application.

16. The computing device of claim 15, wherein the resource configuration for the application is determined based on executing an optimization algorithm using the optimization objective and the performance profiles of the one or more functions.

17. The set of non-transitory machine-readable media of claim 14, wherein the optimization algorithm is one of a Tabu search algorithm, a particle swarm optimization algorithm, and a genetic algorithm.

18. The set of non-transitory machine-readable media of claim 13, wherein the operations further comprise:
determining whether a performance profile of a particular function of the one or more functions accurately reflects an actual performance of the particular function;
updating the performance profile of the particular function in response to a determination that the performance profile of the particular function does not accurately reflect the actual performance of the particular function;
determining an updated resource configuration for the application based on the updated performance profile of the particular function; and
assigning the updated resource configuration to the application.

19. The computing device of claim 16, wherein the optimization algorithm is one of a Tabu search algorithm, a particle swarm optimization algorithm, and a genetic algorithm.

20. The computing device of claim 15, wherein the computer code, when executed by the one or more processors, further cases the computing device to:
determine whether a performance profile of a particular function of the one or more functions accurately reflects an actual performance of the particular function;
update the performance profile of the particular function in response to a determination that the performance profile of the particular function does not accurately reflect the actual performance of the particular function;
determine an updated resource configuration for the application based on the updated performance profile of the particular function; and
assign the updated resource configuration to the application.
